(19) United States
(12) Patent Application Publication
(10) Pub. No.: US 2024/0023160 A1
(43) Pub. Date: Jan. 18, 2024

(54) Methods, Apparatus and Machine-Readable Media Relating to Reporting Failure in a Wireless Network

(71) Applicant: Telefonaktiebolaget LM Ericsson (publ), Stockholm (SE)

(72) Inventor: Min Wang, Luleå (SE)

(21) Appl. No.: 17/768,585

(22) PCT Filed: Nov. 3, 2020
(86) PCT No.: PCT/EP2020/080825

§ 371 Date: Apr. 13, 2022

Related U.S. Application Data
(60) Provisional application No. 62/931,847, filed on Nov. 7, 2019.

(51) Int. Cl. H04W 74/08; H04L 1/1829

(52) U.S. Cl. CPC H04W 74/0808; H04L 1/1851

(57) ABSTRACT

The disclosure provides methods in a wireless device and a network node. A method performed by a wireless device comprises transmitting, to a network node, a report message comprising an indication of consistent failure experienced by the wireless device when attempting to communicate with the network node or another network node; and starting or restarting a retransmission timer upon transmission of the report message and, upon expiry of the retransmission timer, retransmitting the report message.

### TECHNICAL FIELD

Embodiments of the disclosure relate to wireless communications, and particularly to methods, apparatus and machine-readable media relating to reporting failure in a wireless network.

### BACKGROUND

Generally, at terms used herein are to be interpreted according to their ordinary meaning in the relevant technical field, unless a different meaning is clearly given and/or is implied from the context in which it is used. At references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments with be apparent from the following description.

### NR in Unlicensed Spectrum (NR-U)

Currently the 5th generation of cellular systems, called New Radio (NR), is being standardized in the Third Generation Partnership Project (3GPP). NR is being developed for maximum flexibility to support multiple and substantially different use cases. Besides the typical mobile broadband use case, supported use cases include machine type communication (MTC), ultra-reliable low-latency communications (URLLC), side-link device-to-device (D2D) and several others.

In NR, the basic scheduling unit is called a slot. A slot consists of 14 orthogonal frequency-division multiplex (OFDM) symbols for the normal cyclic prefix configuration. NR supports many different subcarrier spacing configurations and at a subcarrier spacing of 30 kHz the OFDM symbol duration is ˜33 μs. As an example, a slot with 14 symbols for the same subcarrier-spacing is 500 μs long (including cyclic prefixes).

NR also supports flexible bandwidth configurations for different user equipments (UEs) on the same serving cell. In other words, the bandwidth monitored by a UE and used for its control and data channels may be smaller than the carrier bandwidth. One or multiple bandwidth part (BWP) configurations for each component carrier can be semi-statically signaled to a UE, where a bandwidth part consists of a group of contiguous physical resource blocks (PRBs). Reserved resources can be configured within the bandwidth part. The bandwidth of a bandwidth part is equal to or smaller than the maximal bandwidth capability supported by a UE.

NR is targeting both licensed and unlicensed bands and a work item named NR-based Access to Unlicensed Spectrum (NR-U) was started in January 2019. Allowing unlicensed networks, i.e., networks that operate in shared spectrum (or unlicensed spectrum), to use the available spectrum more effectively is an attractive approach to increasing system capacity. Although unlicensed spectrum does not match the qualities of the licensed regime, solutions that allow an efficient use of it as a complement to licensed deployments have the potential to bring great value to 3GPP operators, and, ultimately, to the 3GPP industry as a whole. It is expected that some features in NR will need to be adapted to comply with the special characteristics of the unlicensed band as well as also different regulations. Subcarrier spacings of 15 or 30 kHz are the most promising candidates for NR-U OFDM numerologies for frequencies below 6 GHz (although the present disclosure is not limited to such subcarrier spacings).

When operating in unlicensed spectrum many regions in the world require a device to sense the medium as free before transmitting. This operation is often referred to as listen before talk (LBT). There are many different mechanisms for LBT, depending on which radio technology the device uses and which type of data it wants to transmit. Common to all mechanisms is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including multiple sub-bands/channels, e.g., multiple LBT sub-bands (i.e., the frequency part having a bandwidth equal to the LBT bandwidth). A device is only allowed to transmit on sub-bands where the medium is sensed as free. Again, there are different ways in which the sensing could be done when multiple sub-bands are involved.

There are at least two ways a device can operate over multiple sub-bands. One way is that the transmitter/receiver bandwidth is changed depending on which sub-bands were sensed as free. In this setup, there is only one component carrier (CC) and the multiple sub-bands are treated as a single channel with a larger bandwidth. The other way is that the device operates almost independent processing chains for each channel. Depending on how independent the processing chains are, this option can be referred to as either carrier aggregation (CA) or dual connectivity (DC).

### Channel Access Procedure in NR Unlicensed Spectrum

Listen-before-talk is designed for unlicensed spectrum co-existence with other radio-access technologies (RATs). In this mechanism, a radio device applies a clear channel assessment (CCA) check (i.e. channel sensing) before any transmission. The transmitter may perform energy detection (ED) over a time period, and compare the detected energy to a threshold (ED threshold) in order to determine if a channel is idle. If the channel is determined to be occupied, the transmitter performs a random back-off within a contention window before the next CCA attempt. In order to protect acknowledgement (ACK) transmissions, the transmitter defers for a period after each busy CCA slot prior to resuming back-off. As soon as the transmitter has grasped access to a channel (e.g., the channel is determined to be free), the transmitter is allowed to perform transmission up to a maximum time duration (namely, the maximum channel occupancy time (MCOT)). For quality-of-service (QoS) differentiation, a channel access priority based on the service type has been defined. For example, four LBT priority classes are defined for differentiation of contention window sizes (CWS) and MCOT between services.

Prior to any transmission in the uplink, the UE may need to perform a LBT operation to grasp the channel. For instance, the medium access control (MAC) layer initiates a transmission, the MAC layer requests the physical (PHY) layer to initiate the LBT operation, and the PHY layer sends an indicator to the MAC indicating the LBT outcome (e.g., success or failure).

### Radio Link Monitoring in LTE and NR Licensed

One of the main intentions of the radio link failure (RLF) procedure in Long Term Evolution (LTE) was to assist the UE to perform a fast and reliable recovery without going via RRC_IDLE. This is beneficial to avoid unnecessary latency owing to the need to perform random-access channel (RACH) access and radio resource control (RRC) connection establishment from RRC IDLE. Radio link monitoring in LTE is illustrated in FIG. 1.

In LTE, there are several reasons that may lead to radio link failure, including:
1) Timer T310 expiry

While the UE is in RRC connected mode, the UE monitors the downlink radio channel quality based on a downlink reference symbol. The UE compares the measured downlink channel quality with the out-of-sync and in-sync thresholds, Qout and Qin respectively. The physical channel evaluates the downlink channel quality, and periodically sends an indication of out-of-sync or in-sync, to layer 3. The UE layer 3 then evaluates if a radio link failure has occurred based on the in-sync and out-of-sync indications that are output from the layer 3 filter. When the number of consecutively received out-of-sync indications exceeds the value N310, a timer T310 is started. While T310 is running, the radio link is considered to be recovered if the UE consecutively receives N311 in-sync indications from the physical layer.

When the timer T310 expires, a radio link failure is declared by the UE.
2) Maximum number of radio link control (RLC) retransmissions in uplink is reached
3) Handover failure and timer T304 expiry

During a handover procedure, a timer T304 is started when the UE receives a handover command from the source cell. The value of the timer T304 should be set to allow the UE to perform a maximum number of RACH access attempts to the target cell. When the timer T304 expires without successful establishment of a connection to the target cell, a radio link failure due to handover is detected.

When a radio link failure is triggered, a radio connection re-establishment procedure is triggered. In this procedure, a UE shall first perform cell search to determine the cell for radio link re-establishment. According to 3GPP TS 36.300 v 15.7.0, a UE can select the same cell, a different cell from the same evolved NodeB (eNB), or a prepared cell from a different eNB, wherein the activity can be resumed (i.e., the UE stays in connected mode) via a radio connection re-establishment procedure since the previous UE context can be retrieved by inter-cell communication. However, when a prepared cell is not available, the UE selects an unprepared cell. In this case, the UE has to go to idle mode and try to setup the radio connection afterwards. In this case, activity of the UE cannot be resumed. Table 10.1.6-1 from 3GPP TS 36.300 v 15.7.0, copied below, guides the UE behavior for target cell selection.

TABLE 1
Table 10.1.6-1 from 3GPP TS 36.300 v 15.7.0

| Cases | First Phase | Second Phase | T2 expired |
|---|---|---|---|
| UE returns to | Continue as | Activity is resumed | Go via |
| the same cell | if no radio | by means of explicit | RRC_IDLE |
| | problems | signalling between | |
| | occurred | UE and eNB | |
| UE selects a | N/A | Activity is resumed | Go via |
| different cell | | by means of explicit | RRC_IDLE |
| from the same | | signalling between | |
| eNB | | UE and eNB | |
| UE selects a cell | N/A | Activity is resumed | Go via |
| of a prepared | | by means of explicit | RRC_IDLE |
| eNB (NOTE) | | signalling between | |
| | | UE and eNB | |
| UE selects a cell | N/A | Go via RRC_IDLE | Go via |
| of a different | | | RRC_IDLE |
| eNB that is not | | | |
| prepared (NOTE) | | | |

NOTE:
a prepared eNB is an eNB which has admitted the UE during an earlier executed HO preparation phase, or obtains the UE context during the Second Phase.

### Beam Failure Recovery Procedure in NR

In NR, the MAC entity may be configured by RRC with a beam failure recovery procedure which is used for indicating to the serving 5G NodeB (gNB) of a new synchronization signal block (SSB) or channel-state information reference signal (CSI-RS) when beam failure is detected on the serving SSB(s)/CSI-RS(s). Beam failure is detected by counting beam failure instance indications from the lower layers to the MAC entity.

The MAC entity shall:
1> if beam failure instance indication has been received from lower layers:
2> start or restart the beamFailureDetectionTimer;
2> increment BFI_COUNTER by 1;
2> if BFI_COUNTER>=beamFailureInstanceMaxCount:
3> if beamFailureRecoveryConfig is configured:
4> start the beamFailureRecoveryTimer, if configured;
4> initiate a Random Access procedure (see subclause 5.1) on the SpCell by applying the parameters powerRampingStep, preambleReceivedTargetPower, and preambleTransMax configured in beamFailureRecoveryConfig.
3> else:
4> initiate a Random Access procedure (see subclause 5.1) on the SpCell.
1> if the beamFailureDetectionTimer expires:
2> set BFI_COUNTER to 0.
1> if the Random Access procedure is successfully completed (see subclause 5.1):
2> stop the beamFailureRecoveryTimer, if configured;
2> consider the Beam Failure Recovery procedure successfully completed.

### PUCCH SR Failure Handling Procedure (see 3GPP TS 38.321 v 15.7.0)

A Scheduling Request (SR) is used for requesting uplink shared channel (UL-SCH) resources for a new transmission.

The MAC entity may be configured with zero, one, or more SR configurations. An SR configuration consists of a set of physical uplink control channel (PUCCH) resources for SR across different BWPs and cells. For a logical channel, at most one PUCCH resource for SR is configured per BWP.

Each SR configuration corresponds to one or more logical channels. Each logical channel may be mapped to zero or one SR configuration, which is configured by RRC.

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled. All pending SR(s) triggered prior to the MAC protocol data unit (PDU) assembly shall be cancelled and each respective sr-ProhibitTimer shall be stopped when the MAC PDU is transmitted and this PDU includes a buffer status report (BSR) MAC control element (CE) which contains buffer status up to (and including) the last event that triggered a BSR prior to the MAC PDU assembly. All pending SR(s) shall be cancelled when the UL grant(s) can accommodate all pending data available for transmission.

Only PUCCH resources on a BWP which is active at the time of SR transmission occasion are considered valid.

As long as at least one SR is pending, the MAC entity shall for each pending SR:
1> if the MAC entity has no valid PUCCH resource configured for the pending SR:
2> initiate a Random Access procedure (see subclause 5.1 of TS 38.321 v 15.7.0) on the SpCell and cancel the pending SR.
1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap; and
2> if the PUCCH resource for the SR transmission occasion does not overlap with a UL-SCH resource:
3> if SR_COUNTER<sr-TransMax:
4> increment SR_COUNTER by 1;
4> instruct the physical layer to signal the SR on one valid PUCCH resource for SR;
4> start the sr-ProhibitTimer.
3> else:
4> notify RRC to release PUCCH for all Serving Cells;
4> notify RRC to release SRS for all Serving Cells;
4> clear any configured downlink assignments and uplink grants;
4> initiate a Random Access procedure (see subclause 5.1 of TS 38.321 v 15.7.0) on the SpCell and cancel all pending SRs.

NOTE: The selection of which valid PUCCH resource for SR to signal SR on when the MAC entity has more than one overlapping valid PUCCH resource for the SR transmission occasion is left to UE implementation.

The MAC entity may stop ongoing Random Access procedures, if any, due to a pending SR which has no valid PUCCH resources configured, which was initiated by MAC entity prior to the MAC PDU assembly. Such a Random Access procedure may be stopped when the MAC PDU is transmitted using an uplink (UL) grant other than a UL grant provided by Random Access Response, and this PDU includes a BSR MAC CE which contains buffer status up to (and including) the last event that triggered a BSR (see subclause 5.4.5 of TS 38.321 v 15.7.0) prior to the MAC PDU assembly, or when the UL grant(s) can accommodate all pending data available for transmission.

### MAC PDU Format

As specified in the clause 6.1.2 in 3GPP TS 38.321 V15.7.0, a MAC PDU consists of one or more MAC subPDUs. Each MAC subPDU consists of one of the following:
A MAC subheader only (including padding);
A MAC subheader and a MAC service data unit (SDU);
A MAC subheader and a MAC CE;
A MAC subheader and padding.

The MAC SDUs are of variable sizes.

Each MAC subheader corresponds to either a MAC SDU, a MAC CE, or padding.

A MAC subheader except for fixed sized MAC CE, padding, and a MAC SDU containing UL common control channel (CCCH) consists of the four header fields R/F/LCID/L. A MAC subheader for fixed sized MAC CE, padding, and a MAC SDU containing UL CCCH consists of the two header fields R/LCID.

MAC CEs are placed together. DL MAC subPDU(s) with MAC CE(s) is placed before any MAC subPDU with MAC SDU and MAC subPDU with padding as depicted in FIG. 5. UL MAC subPDU(s) with MAC CE(s) is placed after all the MAC subPDU(s) with MAC SDU and before the MAC subPDU with padding in the MAC PDU as depicted in FIG. 6. The size of padding can be zero.

A maximum of one MAC PDU can be transmitted per TB per MAC entity.

The MAC subheader consists of the following fields:
LCID: The Logical Channel ID field identifies the logical channel instance of the corresponding MAC SDU or the type of the corresponding MAC CE or padding as described in Tables 6.2.1-1 and 6.2.1-2 for the DL-SCH and UL-SCH respectively. There is one LCID field per MAC subheader. The LCID field size is 6 bits;
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
R: Reserved bit, set to 0.

The MAC subheader is octet aligned.

Three examples of MAC subheaders are shown in FIGS. 2, 3 and 4.

TABLE 2
Table 6.2.1-1 in 3GPP TS 38.321 V
15.7.0: Values of LCID for DL-SCH

| Index | LCID values |
|---|---|
| 0 | CCCH |
| 1-32 | Identity of the logical channel |
| 33-46 | Reserved |
| 47 | Recommended bit rate |
| 48 | SP ZP CSI-RS Resource Set |
| | Activation/Deactivation |
| 49 | PUCCH spatial relation |
| | Activation/Deactivation |
| 50 | SP SRS Activation/Deactivation |
| 51 | SP CSI reporting on PUCCH |
| | Activation/Deactivation |
| 52 | TCI State Indication for UE-specific PDCCH |
| 53 | TCI States Activation/Deactivation for UE- |
| | specific PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE 3
Table 6.2.1-2 in 3GPP TS 38.321 V
15.7.0: Values of LCID for UL-SCH

| Index | LCID values |
|---|---|
| 0 | CCCH of size 64 bits (referred to as |
| | “CCCH1” in TS 38.331 [5]) |
| 1-32 | Identity of the logical channel |
| 33-51 | Reserved |
| 52 | CCCH of size 48 bits (referred to as “CCCH” |
| | in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

### Consistent UL LBT Failure Handling

Listen-Before-Talk was introduced above in the context of wireless communications using unlicensed spectrum. In such scenarios, a UE is required to sense the channel before transmitting, to determine whether the channel is busy or idle. If the channel is busy, the UE defers its transmission for a period of time (perhaps more than once) and this is known as LBT failure. In particularly crowded radio environments, it may happen that a UE experiences several LBT failures, such that performance is significantly adversely affected. This event may be called consistent LBT failure. One mechanism for detecting consistent LBT failure is as follows (enhancements to this mechanism are not precluded):

A timer and a counter are introduced. The timer is started or restarted when UL LBT failure occurs. The counter is reset when the timer expires and incremented when UL LBT failure happens. A maximum number of LBT failures is defined, and consistent LBT failure is detected when the counter reaches the maximum number of LBT failures.

Work regarding the detailed mechanism is not finalized. As an example, the mechanism may be implemented in the NR MAC spec (i.e., 3GPP TS 38.321 V 15.7.0) similar to the Beam Failure Detection and Recovery procedure (i.e., in clause 5.17 in 3GPP TS 38.321 V 15.7.0 and also described above):

The MAC entity may be configured by RRC with a consistent LBT failure recovery procedure. Consistent LBT failure is detected by counting LBT failure indications, for all UL transmissions, from the lower layers to the MAC entity.

RRC configures the following parameters in the Ibt-FailureRecoveryConfig:
Ibt-FailureInstanceMaxCount for the consistent LBT failure detection;
Ibt-FailureDetectionTimer for the consistent LBT failure detection;

The following UE variables are used for the consistent LBT failure detection procedure:
LBT_COUNTER: counter for LBT failure indication which is initially set to 0.

The MAC entity shall:
1> if LBT failure indication has been received from lower layers:
2> start or restart the Ibt-FailureDetectionTimer;
2> increment LBT_COUNTER by 1;
2> if LBT_COUNTER>=Ibt-FailureInstanceMaxCount
3> initiate [a recovery mechanism (FFS)]
1> if the Ibt-FailureDetectionTimer expires; or
[1> if Ibt-FailureDetectionTimer or Ibt-FailureInstanceMaxCount is reconfigured by upper layers:]
2> set LBT_COUNTER to 0.
[1> if the recovery mechanism (FFS) is successful:
2> set LBT_COUNTER to 0;
2> consider the LBT Failure Recovery procedure successfully completed]

### SUMMARY

There currently exist certain challenge(s).

It would be useful for the UE to be able to report the occurrence of one or more of the failures noted above to the network. For example, if the UE were able to report the occurrence of consistent LBT failure, the network is enabled to take one or more actions to reduce the likelihood of the UE experiencing further LBT failure, or to mitigate the effects of such consistent LBT failure. Similarly, if the UE were able to report the occurrence of consistent beam failure, the network is enabled to take one or more actions to reduce the likelihood of the UE experiencing further beam failure, or to mitigate the effects of such consistent beam failure. Currently mechanisms for reporting such events to the network are not well defined.

There are several remaining issues to be addressed in order to support the new reporting mechanisms.
Issue 1: what are the UE behaviors upon triggering of the new MAC CE?
Issue 2: what is the priority order for the new MAC CE compared to the existing MAC CEs and LCHs?
Issue 3: how to guarantee that the MAC CE is reliably transmitted by a UE to its serving gNB?

Certain aspects of the present disclosure and their embodiments may provide solutions to these or other challenges. In this disclosure, we have studied several remaining issues for the new MAC CEs (e.g., Consistent UL LBT Failure Indication MAC CE, BFRQ indication MAC CE). Detailed UE behaviours regarding how to trigger and transmit the MAC CE are proposed. A priority order between the new MAC CE and existing MAC CEs is proposed. Mechanisms on how to improve the transmission reliability for the new MAC CEs are also proposed.

There are, proposed herein, various embodiments which address one or more of the issues disclosed herein. A first aspect provides a method performed by a wireless device, comprising: method performed by a wireless device, the method comprising: transmitting, to a network node, a report message comprising an indication of consistent failure experienced by the wireless device when attempting to communicate with the network node or another network node; and starting or restarting a retransmission timer upon transmission of the report message and, upon expiry of the retransmission timer, retransmitting the report message.

A further example provides a method performed by a base station or network node, comprising: receiving, from a wireless device, a report message comprising an indication of consistent failure experienced by the wireless device when attempting to communicate with the base station or another base station.

Certain embodiments may provide one or more of the following technical advantage(s). For example, embodiments of the disclosure address issues for the reporting of consistent failure (e.g., the new MAC CEs described above). Some embodiments of the disclosure enable a new MAC CE to be treated with higher priority than one or more other MAC CEs. In this way, the failure event (either consistent UL LBT failure or a beam failure) in a serving cell can be reported quickly and the network (e.g., gNB) can take faster recovery action in the corresponding cell.

### BRIEF DESCRIPTION OF THE DRAWINGS

FIG. 1 shows radio link monitoring of a serving cell followed by RRC re-establishment to a target cell;

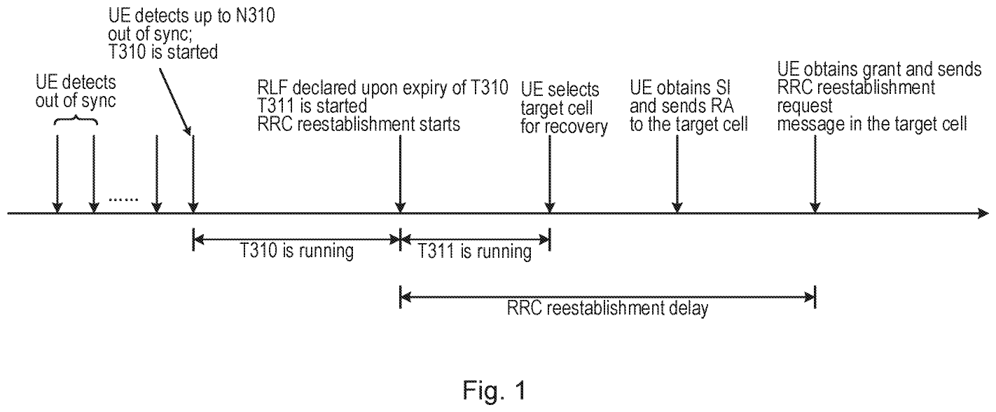

FIGS. 2 to 4 show three examples of MAC sub-headers;

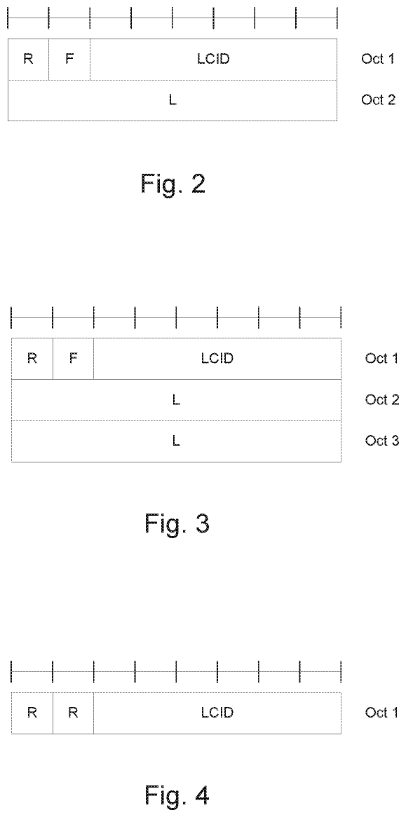

FIGS. 5 and 6 show examples of DL and UL MAC PDUs, respectively;

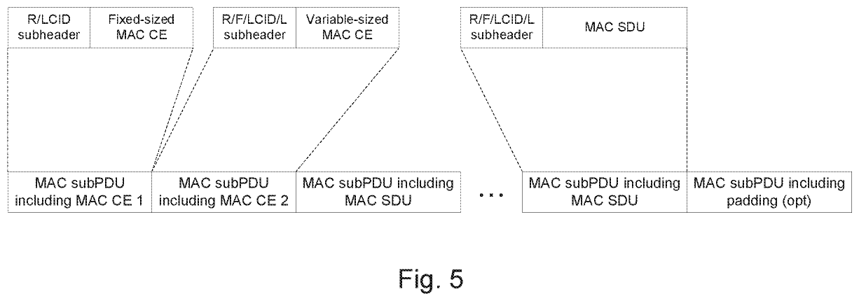

FIG. 7 is a flowchart of a method according to embodiments of the disclosure;

FIG. 8 shows a virtualization apparatus according to embodiments of the disclosure;

FIG. 9 is a flowchart of a method according to embodiments of the disclosure;

FIG. 10 shows a virtualization apparatus according to embodiments of the disclosure;

FIG. 11 shows a wireless network according to embodiments of the disclosure;

FIG. 12 shows a user equipment according to embodiments of the disclosure;

FIG. 13 shows a virtualization environment according to embodiments of the disclosure;

FIG. 14 shows a telecommunication network connected via an intermediate network to a host computer according to embodiments of the disclosure;

FIG. 15 shows a host computer communicating via a base station with a user equipment over a partially wireless connection according to embodiments of the disclosure;

FIGS. 16 and 17 show methods implemented in a communication system including a host computer, a base station and a user equipment according to embodiments of the disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

According to embodiments of the disclosure, a UE is enabled to report consistent failure to communicate with a network node such as a base station. The consistent failure may relate to consistent LBT failure, such as may occur when utilizing unlicensed spectrum (e.g., served by an NR-U system). Embodiments of the disclosure relating to unlicensed spectrum are not limited to NR-U, but can be applied in other unlicensed spectrum systems (especially cellular systems) such as Licensed-Assisted Access (LAA)/enhanced LAA (eLAA)/further enhanced LAA (feLAA)/MulteFire etc. The consistent failure may alternatively or additionally relate to beam failure, such as may occur when a measured radio parameter for one or more beams transmitted by a network node falls below one or more thresholds. In either case, transmits a report message comprising an indication of the consistent failure experienced by the UE to a network node, such as one or more of its serving base stations (e.g., gNBs). The indication of the consistent failure may comprise an indication of consistent LBT failure, or a beam failure recovery request (BFRQ) message, for example.

Multiple reporting mechanisms are proposed, and in some embodiments different reporting mechanisms are provided for different deployment scenarios. Upon reception of the report message from a UE, the network is able to take suitable actions to reconfigure the UE (and/or other UEs who may also suffer from failures). In this way, both latency and signaling overhead can be reduced.

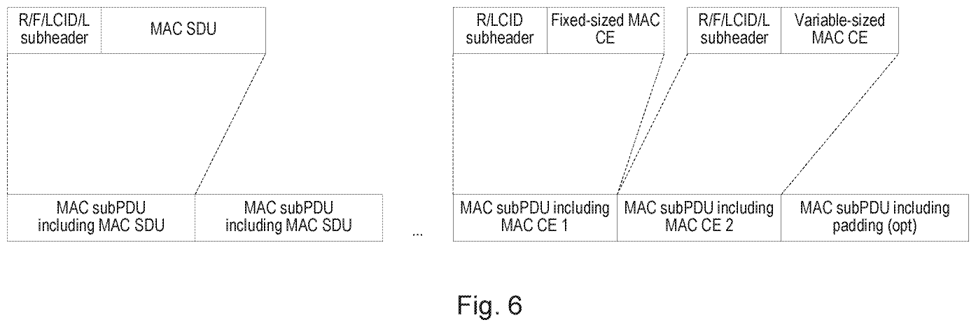

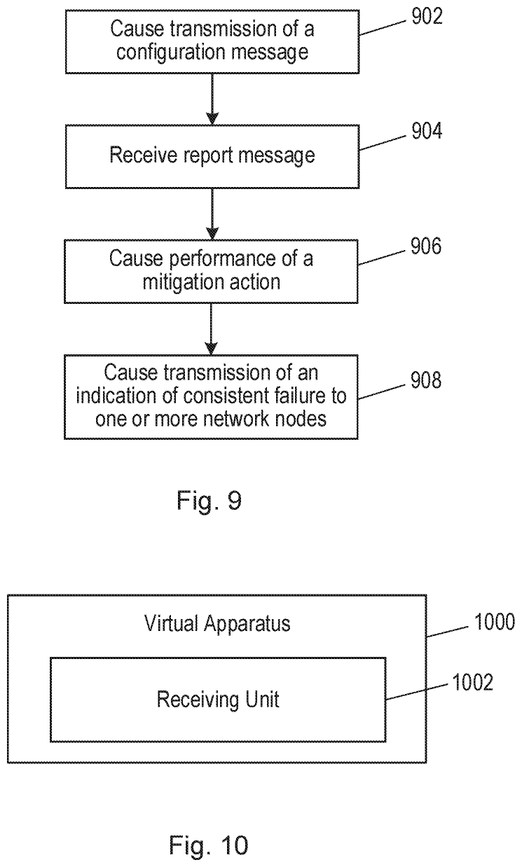

Embodiments of the disclosure will be described in more detail with respect to FIGS. 7 and 9 below, which set out methods performed by a wireless device (e.g., a UE) and a network node (e.g., a base station) respectively.

FIG. 7 depicts a method in accordance with particular embodiments. The method may be performed by a wireless device (e.g., a UE). The wireless device may correspond to the wireless device 1110 or the UE 1200 described below. The wireless device may be in communication with a cellular network and, in some embodiments such as those relating to LBT failure, the wireless device may utilize unlicensed spectrum. In such embodiments, the cellular network may implement one or more of NR-U, LAA, eLAA, feLAA, MulteFire, etc.

The method begins at step 702, in which the wireless device receives a configuration message from a network node (e.g., a serving network node such as a base station), comprising an indication of a configuration for the reporting of consistent failures experienced by the wireless device. The network node may correspond to the network node 1160 described below.

The configuration message may be transmitted by the network node via dedicated signalling for the wireless device (e.g., via RRC signalling) or broadcast (e.g., via system information). In one embodiment, the wireless device may be provided with multiple configurations for reporting consistent failures, with the network dynamically signalling (e.g., via the configuration message or a further configuration message) an indication of a selected one of the multiple configurations to be used by the wireless device. In the latter case, an indication of the selected configuration may be signalled via DCI or MAC CE based signaling. The configurations for reporting consistent failure may vary between different scenarios, such as between different services accessed by the wireless device; different logical channels or logical channel groups; or different channel access priority classes. Thus the configuration(s) indicated in the configuration message may also be specific to different services accessed by the wireless device; different logical channels or logical channel groups; or different channel access priority classes.

The configuration itself may comprise a priority order for the reporting of consistent failures to the network node. For example, the wireless device may be configured with multiple serving cells (e.g., a primary cell, PCell, one or more secondary cells, SCells, one or more special cells, SpCells, etc). These serving cells may be implemented by one or multiple network nodes or base stations (e.g., gNBs).

The priority order may relate to the order in which report messages are sent for consistent failures experienced by the wireless device. Thus, for example, the wireless device may report consistent failure experienced when attempting to access a first cell, having relatively high priority, before reporting consistent failure experienced when attempting to access a second cell, having relatively low priority.

The priority order may additionally or alternatively relate to the order in which radio resources are selected for the transmission of report messages (see step 706 below). For example, a wireless device may transmit a report message using radio resources on a first cell having relatively high priority, before transmit a report message using radio resources on a second cell having relatively low priority. This priority order may be different to that described above, relating to the priority of cells on which the consistent failures are experienced. In this case, the configuration message may comprise a downlink control information (DCI) in which an indication of the granted radio resources as well as their priority is given (e.g., for dynamic scheduling), or an information element (IE) such as the RRC IE ConfiguredGrantConfig (e.g., for configured scheduling).

The configuration may comprise a complete order for each of the serving cells, such that each serving cell has a different priority value and a different place in the priority order. Alternatively, the configuration may comprise a priority value for each serving cell, where the same priority value may be assigned to more than one serving cell. The configuration may be signalled in a single configuration message from one cell (e.g., the PCell), or in respective configuration messages from respective cells.

In a further alternative, the configuration may comprise one or more rules to be applied by the wireless device to enable the wireless device to determine the priority order. The rules may relate to one or more of: the type of cells (e.g., PCell, SCell, SpCell, etc); the index values of the cells; the latency of transmissions on the cells; the robustness or reliability of transmissions on the cells; the bandwidth of the cells; and the ability of the cells to meet QoS criteria. These rules may alternatively be hard-coded into the wireless device, such that step 702 can be omitted altogether.

In step 704, the wireless device experiences one or more failures, and thus detects a consistent failure event. The consistent failure event may relate to LBT failure or beam failure.

An LBT failure may occur when the wireless device attempts to grasp access to a channel on unlicensed spectrum, prior to transmitting on that channel. When attempting to grasp access to the channel, the wireless device performs a LBT procedure, which comprises listening to the channel for a period of time prior to transmitting. For example, the wireless device may utilize energy detect (ED) to measure the received energy on the channel, and compare that energy to a threshold to determine whether the channel is free or not. In another example, the wireless device may utilize signal detect (SD) to detect signals by one or more other wireless devices on the channel, and thus determine whether the channel is free or not. In either case, if the channel is not free (i.e., the channel is busy or occupied), the wireless device may backoff for a period of time before re-attempting to grasp access to the channel (and performing a further LBT procedure).

Consistent LBT failure, in which the wireless device experiences a threshold number of LBT failures, typically within a short period of time, may be detected by the wireless device implementing a counter and a timer. The timer is started or restarted upon experiencing a LBT failure. The counter is incremented upon experiencing a LBT failure, and reset when the timer expires. Consistent LBT failure is detected when the counter reaches a threshold value. The effect of this mechanism is to detect consistent LBT failure when the wireless device experiences a threshold number of LBT failures, with each LBT failure occurring within a short time of its immediately preceding LBT failure.

A beam failure may occur when a measured radio parameter for a particular beam transmitted over a serving cell (such as reference signal received power (RSRP), reference signal received quality (RSRQ), etc) falls below one or more thresholds. Consistent beam failure may be detected by the wireless device implementing a counter and a timer. The timer is started or restarted upon experiencing a beam failure. The counter is incremented upon experiencing a beam failure, and reset when the timer expires. Consistent beam failure is detected when the counter reaches a threshold value. The effect of this mechanism is to detect consistent beam failure when the wireless device experiences a threshold number of beam failures, with each beam failure occurring within a short time of its immediately preceding beam failure.

Consistent failure may be detected in respect of particular radio resources, such as particular bandwidth parts, for example. Additionally or alternatively, where the wireless device is configured with multiple cells served by one or more network nodes or base stations, the consistent failure may be detected in respect of one or more of the multiple cells.

In step 706, the wireless device identifies suitable radio resources (e.g., time resources and/or transmission frequency resources) on which to transmit a report of the detected consistent failure to the network.

For example, if the wireless device has an available grant of uplink radio resources for a new transmission, those radio resources may be identified for the transmission of a report message to the network. The grant may be for transmissions on a cell where the consistent failure has been experienced or, in one embodiment, on a different cell where consistent failure has not been experienced. If the wireless device does not have any grant of uplink radio resources available, the wireless device may transmit a scheduling request for a grant of uplink radio resources on which to transmit a report message to the network. Again, the scheduling request may be transmitted on a cell where the consistent failure has been experienced or, in one embodiment, on a different cell where consistent failure has not been experienced.

Where the wireless device has multiple available grants of uplink radio resources (e.g., on the same or different serving cells), the wireless device may select one of the multiple available grants for the transmission of a report message. The selection may utilize a priority order of UL grants, such as that configured in step 702, for example. Alternatively, the selection may utilize a particular rule (which may be configured or hardcoded). For example, the wireless device may select radio resources based on a cell index value on which, the grants are configured: an available UL grant may be selected on a cell having a lowest cell index value, or a highest cell index value, for example. Alternatively, the wireless device may select a grant on a cell which has the best transmission reliability (e.g., best radio conditions, such as RSRP, RSRQ, SINR, etc), or the lowest latency. In the latter case, the latency may be measured in numerous ways, such as: the PUSCH duration in a grant; the length of time between a transmission and receipt of a corresponding acknowledgment message on the cell; the radio channel quality on the cell (e.g., RSRQ).

In step 708, the wireless device transmits a report message, to a network node, comprising an indication of the consistent failures experienced by the wireless device (e.g., in step 704), and using the resources identified in step 706.

The wireless device may have various data (user plane data and/or control plane data) for transmission to the network. Thus the report message may be assigned to the resources identified in step 706 along with this other data. The data may belong to or be associated with logical channels, with each logical channel or logical channel group (where a logical channel group comprises one or more logical channels) having an associated priority for assignment to the radio resources. In one embodiment, the report message belongs to a first logical channel, which has a lower priority than a second logical channel to which a Cell Radio Network Temporary Identifier Medium Access Control Control Element (C-RNTI MAC CE) belongs. Thus, if data belonging to the second logical channel is available for transmission (e.g., a C-RNTI MAC CE), that data may be assigned to the identified resources prior to the report message (which belongs to the first logical channel). The data belonging to the second logical channel may also be transmitted before the report message in the identified resources.

Additionally or alternatively, the priority of the first logical channel (to which the report message belongs) may be higher than a priority of one or more third logical channels to which one or more of the following belong: a Configuration Grant Confirmation; a Buffer Status Report; a Single- or Multiple-Entry Power Headroom Report; user data; a Recommended bit rate query; and a Buffer Status Report for padding. Thus, if data belonging to the third logical channels is available for transmission (e.g., a C-RNTI MAC CE), that data may be assigned to the identified resources after the report message (which belongs to the first logical channel). The data belonging to the first logical channel may also be transmitted before the data belonging to the third logical channels in the identified resources.

In a particular embodiment, the priority of the logical channels may be defined as follows (highest priority listed first):
C-RNTI MAC CE or data from UL-CCCH;
UL LBT Failure Indication MAC CE or BFRQ Indication MAC CE
Configured Grant Confirmation MAC CE;
MAC CE for BSR, with exception of BSR included for padding;
Single Entry PHR MAC CE or Multiple Entry PHR MAC CE;
data from any Logical Channel, except data from UL-CCCH;
MAC CE for Recommended bit rate query;
MAC CE for BSR included for padding.

The indication of consistent failure is described above as an uplink LBT failure indication MAC CE, or a beam failure recovery request (BFRQ) MAC CE.

In some embodiments, the report message may be transmitted on the identified resources without data from any other logical channel. For example, the wireless device may not have any data available to transmit, or may have data available to transmit belonging to logical channels that do not match any logical channel prioritization (LCP) restrictions associated with the identified resources.

In one embodiment, the indication of consistent failures comprises an indication of consistent LBT failure (e.g., as defined above). In another embodiment, the indication of consistent failures comprises an indication of consistent beam failure (e.g., as defined above). In the latter case, the indication of consistent beam failure may be a beam failure recovery request message.

The indication may relate to one or more LBT failures experienced on a particular portion or part of the bandwidth of a carrier configured for the wireless device, e.g., a particular bandwidth part. Where the wireless device is configured with multiple such bandwidth parts, the report message may comprise respective indications for failures experienced on each bandwidth part.

The report message may be formatted in a number of different ways. For example, in different embodiments of the disclosure, the report message may be conveyed via a transmission on the physical random access channel (PRACH), such as a msg1, msg3 or msgA; alternatively or additionally, the report message may be conveyed via a transmission on an uplink control channel such as the physical uplink control channel (PUCCH); alternatively or additionally, the report message may be formatted in the MAC layer (e.g., as a control element or in a MAC sub-header); alternatively or additionally, the report message may be formatted in the RRC layer (e.g., as a new, dedicated RRC signalling message, or as part of another RRC signalling message).

In one particular embodiment, the report message may comprise a MAC CE. A MAC CE may be configured or defined for the purposes of reporting consistent failures. This MAC CE may be a new MAC CE, dedicated for the purposes of reporting consistent failures, or re-use an existing MAC CE. Where a new MAC CE is defined, a new logical channel identity (LCH ID) may be introduced. The new MAC CE may contain no payload bits. In this case, the new MAC CE together with an identifier such as Cell Radio Network Temporary Identifier (C-RNTI) MAC CE will indicate to the network which wireless device has experienced consistent failures.

Alternatively, the report message may comprise RRC signalling, such as a new RRC signalling message introduced for the purposes of reporting consistent failure. The new message may be named for example as “IbtFailure-Info”. Alternatively, the UE may use an existing RRC signaling message to report the occurrence of consistent failures. One or several RRC information elements (IEs) may be introduced accordingly.

As noted above, in another embodiment the report message may be transmitted over a control channel (e.g., PUCCH). In this embodiment, separate control channel resources (e.g., transmission frequency resources and/or time resources) may be allocated for this purpose. Alternatively or additionally, a new PUCCH format may be defined, or an existing PUCCH format used for transmitting the report message. In one example, the report message uses PUCCH scheduling request (SR) signaling combined with transmission using specific PUCCH resources to indicate consistent failure.

In some embodiments, the report message may comprise no information beyond an indication that the wireless device has experienced consistent failure. In other embodiments, the report message may comprise additional information, such as one or more of the following:
Indication of the event which, triggered transmission of the report message.
Indication that a number of LBT failures has reached a predefined threshold.
Indication that a number of beam failures has reached a predefined threshold.
Channel occupancy, e.g. based on RSSI.
LBT statistics, such as one or more of: number of LBT failures and/or successes, LBT failure/success ratio (e.g. calculated or averaged over a certain time period or using exponential averaging of successive time periods), LBT failure rate (e.g. calculated or averaged over a certain time period or using exponential averaging of successive time periods). Any or all of these statistics may be reported per LBT type, per CAPC, per transmission direction (e.g., UL or DL), per service, per LCH, or per LCG.
One or more radio quality indicators, such as RSRP, RSRQ, RSSI, SNR, SINR, etc.
Service QoS indicators such as latency, packet loss, priority, jitter etc.
Buffer status report.
Power headroom report.
Indications of one or more of the cell(s), bandwidth part(s) (BWPs), carrier(s), channel(s), subband(s) and PLMN(s) on which the failures were experienced, or which suffer from failures or high channel occupancy.
An indication of one or more recovery or mitigation actions that the wireless device would prefer to take place for recovering from or mitigating the failures. The mitigation actions may comprise one or more of: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch. Indications (e.g., indices) may also be included for the new cells/BWPs/carriers/channels/subbands to which the wireless device would prefer to be switched.

As noted above, the wireless device may be configured with multiple serving cells. Thus it may occur that consistent failure is detected in more than one of the serving cells at the same time. Similarly, where consistent failure is detected with a particular granularity (such as per bandwidth part), consistent failure may be detected in multiple bandwidth parts at the same time. In such cases, separate report messages may be transmitted in respect of each consistent failure event, or a single report message may be transmitted in respect of multiple consistent failure events. In either case, the resources identified in step 704 may be insufficient to transmit indications of all detected consistent failures. Thus the wireless device may select from the multiple consistent failure events to be reported via the transmission on the identified resources.

In one embodiment, the wireless device may select the consistent failure events in accordance with the priority order configured in step 702. Thus the priority order may be configured by a configuration message received from a network node. Alternatively or additionally, the wireless device may apply one or more rules to the selection of consistent failure events to be reported.

For example, consistent failure events detected on a PCell may be associated with a higher priority than consistent failure events detected on SCells or SpCells. Cells of the same type (such as SCells) may be differentiated based on one or more of: a cell index value of the cells (e.g., lower cell index values may have higher priority, or vice versa); a bandwidth of the cells (e.g., cells having higher bandwidth may have higher priority); an ability of the cells to satisfy quality of service criteria (e.g., cells which are better able to satisfy quality of service criteria have higher priority); a latency of transmissions to the cells (e.g., cells having lower latency have higher priority); and a robustness of transmissions to the cells (e.g., cells having greater robustness have higher priority).

Consistent failure events associated with higher priority are reported (e.g., report messages are allocated to the available radio resources) prior to consistent failure events with lower priority.

In step 710, one or more timers may be started to control the transmission of further report messages by the wireless device.

In one embodiment, the wireless device starts a retransmission timer upon the transmission of the report message in step 708. The report message is retransmitted to the network node upon expiry of the retransmission timer. The retransmission timer is stopped upon reception of a response message from the network node, such as a positive acknowledgement message (e.g., ACK) or an indication that the network node has taken or initiated some action to mitigate the consistent failure experienced by the wireless device.

Alternatively or additionally, the wireless device may start a prohibit timer upon the transmission of the report message in step 708. While the prohibit timer is running (prior to expiry of the timer) the wireless device is prohibited from transmitted a further report message or a further indication of consistent failure. For example, detection of the consistent failure (e.g., the event triggering transmission of the report message) may be prohibited, and/or transmission of the report message itself may be prohibited while the prohibit timer is running.

The retransmission timer and/or the prohibit timer may be configured for: a particular portion or part of the bandwidth of a carrier configured for the wireless device; a particular cell; a particular carrier; a particular channel; a particular frequency subband; a particular bandwidth part; a particular public land mobile network, PLAN; a particular type of LBT; a particular channel access priority class, CAPC; a particular transmission direction, e.g. UL or DL; a particular service accessed by the wireless device; a particular logical channel; and a particular logical channel group. Thus separate retransmission timers and/or prohibit timers may be configured for these respective scenarios.

It will be noted that, in some embodiments, the reporting of consistent failure may be periodic, or otherwise not triggered by the detection of consistent failure. In this case, a report message for consistent failure may be transmitted regardless of whether or not consistent failure has been experienced by the wireless device (in this case, the report message may thus comprise an indication that no consistent failure has been experienced by the wireless device).

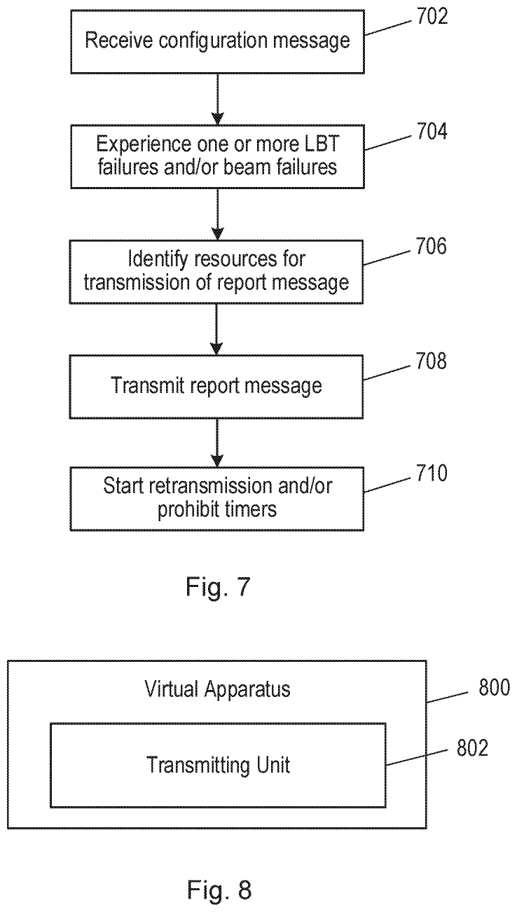

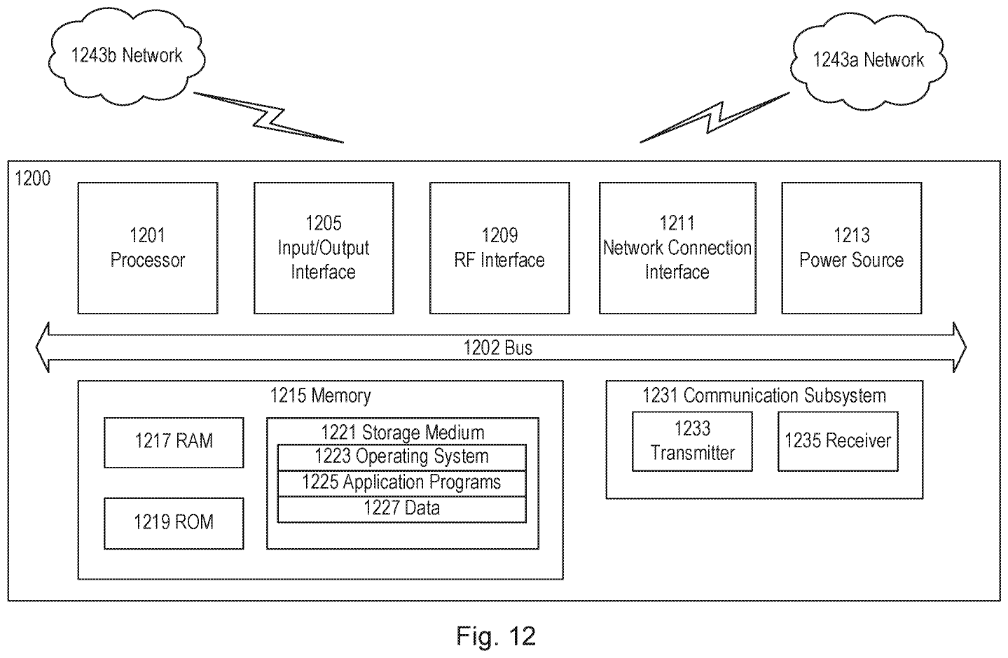

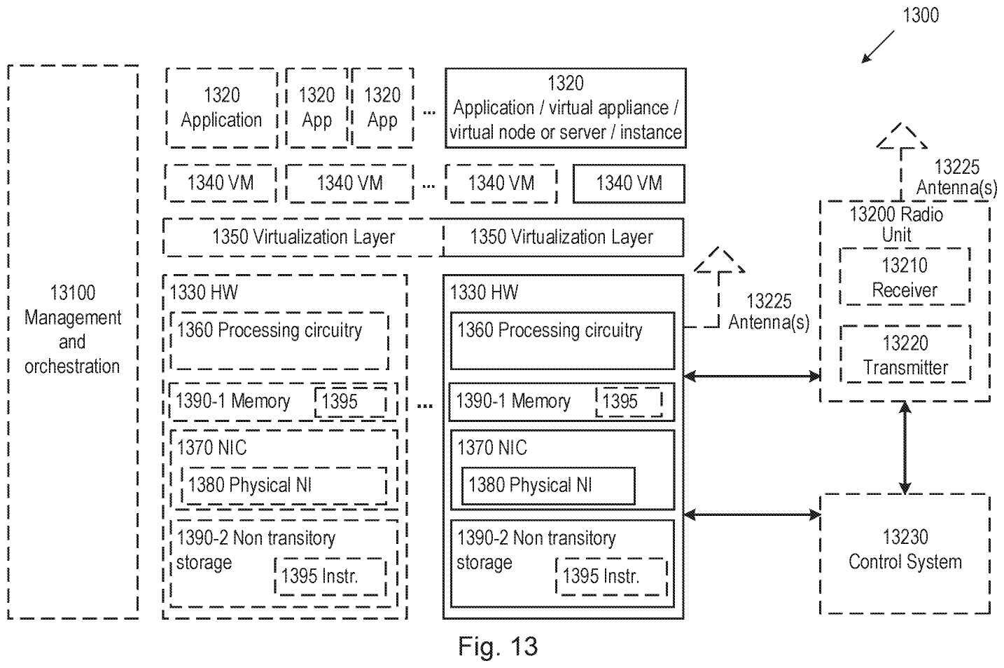

FIG. 8 illustrates a schematic block diagram of an apparatus 800 in a wireless network (for example, the wireless network shown in FIG. 11). The apparatus may be implemented in a wireless device (e.g., wireless device 1110 shown in FIG. 11 or UE 1200 shown in FIG. 12). Apparatus 800 is operable to carry out the example method described with reference to FIG. 7 and possibly any other processes or methods disclosed herein. It is also to be understood that the method of FIG. 7 is not necessarily carried out solely by apparatus 800. At least some operations of the method can be performed by one or more other entities.

Virtual Apparatus 800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 802, and any other suitable units of apparatus 800 to perform corresponding functions according one or more embodiments of the present disclosure.

As illustrated in FIG. 8, apparatus 800 includes transmitting unit 802. Transmitting unit 802 is configured to transmit, to a network node, a report message comprising an indication of consistent failure experienced by the wireless device when attempting to communicate with the network node or another network node. According to embodiments of the disclosure, apparatus 800 may additionally comprise a starting or restarting unit (not illustrated) configured to start or restart a retransmission timer upon transmission of the report message and, upon expiry of the timer, cause retransmission of the report message. The retransmission timer may be stopped upon receipt of a response message from the network node.

FIG. 9 depicts a method in accordance with particular embodiments. The method may be performed by a network node (e.g., a base station, gNB, etc) such as the network node 1160 described below with respect to FIG. 11. The network node may belong to a cellular network and, in some embodiments such as those relating to LBT failure, the network node or a wireless device in communication with the network node may utilize unlicensed spectrum. In such embodiments, the cellular network may implement one or more of NR-U, LAA, eLAA, feLAA, MulteFire, etc.

The method begins at step 902, in which the network node transmits a configuration message to a wireless device (e.g., for which the network node is a serving network node such as a base station), comprising an indication of a configuration for the reporting of consistent failures experienced by the wireless device. The wireless device may correspond to the wireless device 1110 or the UE 1200 described below.

The configuration message may be transmitted by the network node via dedicated signalling for the wireless device (e.g., via RRC signalling) or broadcast (e.g., via system information). In one embodiment, the wireless device may be provided with multiple configurations for reporting consistent failures, with the network dynamically signalling (e.g., via the configuration message or a further configuration message) an indication of a selected one of the multiple configurations to be used by the wireless device. In the latter case, an indication of the selected configuration may be signalled via DCI or MAC CE based signaling. The configurations for reporting consistent failure may vary between different scenarios, such as between different services accessed by the wireless device; different logical channels or logical channel groups; or different channel access priority classes. Thus the configuration(s) indicated in the configuration message may also be specific to different services accessed by the wireless device; different logical channels or logical channel groups; or different channel access priority classes.

The configuration itself may comprise a priority order for the reporting of consistent failures to the network node. For example, the wireless device may be configured with multiple serving cells (e.g., a primary cell, PCell, one or more secondary cells, SCells, one or more special cells, SpCells, etc). These serving cells may be implemented by one or multiple network nodes or base stations (e.g., gNBs).

The priority order may relate to the order in which report messages are sent for consistent failures experienced by the wireless device. Thus, for example, the wireless device may report consistent failure experienced when attempting to access a first cell, having relatively high priority, before reporting consistent failure experienced when attempting to access a second cell, having relatively low priority.

The priority order may additionally or alternatively relate to the order in which radio resources are selected for the transmission of report messages (see step 706 below). For example, a wireless device may transmit a report message using radio resources on a first cell having relatively high priority, before transmit a report message using radio resources on a second cell having relatively low priority. This priority order may be different to that described above, relating to the priority of cells on which the consistent failures are experienced. In this case, the configuration message may comprise a downlink control information (DCI) in which an indication of the granted radio resources as well as their priority is given (e.g., for dynamic scheduling), or an information element (IE) such as the RRC IE ConfiguredGrantConfig (e.g., for configured scheduling).

The configuration may comprise a complete order for each of the serving cells, such that each serving cell has a different priority value and a different place in the priority order. Alternatively, the configuration may comprise a priority value for each serving cell, where the same priority value may be assigned to more than one serving cell. The configuration may be signalled in a single configuration message from one cell (e.g., the PCell), or in respective configuration messages from respective cells.

In a further alternative, the configuration may comprise one or more rules to be applied by the wireless device to enable the wireless device to determine the priority order. The rules may relate to one or more of: the type of cells (e.g., PCell, SCell, SpCell, etc); the index values of the cells; the latency of transmissions on the cells; the robustness or reliability of transmissions on the cells; the bandwidth of the cells; and the ability of the cells to meet QoS criteria. These rules may alternatively be hard-coded into the wireless device, such that step 702 can be omitted altogether.

In step 904, the network node receives a report message, from the wireless device, comprising an indication of consistent failures experienced by the wireless device.

The wireless device may have various data (user plane data and/or control plane data) for transmission to the network. Thus the report message may be assigned to the resources for transmission along with this other data. The data may belong to or be associated with logical channels, with each logical channel or logical channel group (where a logical channel group comprises one or more logical channels) having an associated priority for assignment to the radio resources. In one embodiment, the report message belongs to a first logical channel, which has a lower priority than a second logical channel to which a Cell Radio Network Temporary Identifier Medium Access Control Control Element (C-RNTI MAC CE) belongs. Thus, if data belonging to the second logical channel is available for transmission (e.g., a C-RNTI MAC CE), that data may be assigned to the identified resources prior to the report message (which belongs to the first logical channel). The data belonging to the second logical channel may also be transmitted before the report message in the identified resources.

Additionally or alternatively, the priority of the first logical channel (to which the report message belongs) may be higher than a priority of one or more third logical channels to which one or more of the following belong: a Configuration Grant Confirmation; a Buffer Status Report; a Single- or Multiple-Entry Power Headroom Report; user data; a Recommended bit rate query; and a Buffer Status Report for padding. Thus, if data belonging to the third logical channels is available for transmission (e.g., a C-RNTI MAC CE), that data may be assigned to the identified resources after the report message (which belongs to the first logical channel). The data belonging to the first logical channel may also be transmitted before the data belonging to the third logical channels in the identified resources.

In a particular embodiment, the priority of the logical channels may be defined as follows (highest priority listed first):
C-RNTI MAC CE or data from UL-CCCH;
UL LBT Failure Indication MAC CE or BFRQ Indication MAC CE
Configured Grant Confirmation MAC CE;
MAC CE for BSR, with exception of BSR included for padding;
Single Entry PHR MAC CE or Multiple Entry PHR MAC CE;
data from any Logical Channel, except data from UL-CCCH;
MAC CE for Recommended bit rate query;
MAC CE for BSR included for padding.

The indication of consistent failure is described above as an uplink LBT failure indication MAC CE, or a beam failure recovery request (BFRQ) MAC CE.

In some embodiments, the report message may be transmitted without data from any other logical channel. For example, the wireless device may not have any data available to transmit, or may have data available to transmit belonging to logical channels that do not match any logical channel prioritization (LCP) restrictions associated with the identified resources.

In one embodiment, the indication of consistent failures comprises an indication of consistent LBT failure (e.g., as defined above). In another embodiment, the indication of consistent failures comprises an indication of consistent beam failure (e.g., as defined above). In the latter case, the indication of consistent beam failure may be a beam failure recovery request message.

The indication may relate to one or more LBT failures experienced on a particular portion or part of the bandwidth of a carrier configured for the wireless device, e.g., a particular bandwidth part. Where the wireless device is configured with multiple such bandwidth parts, the report message may comprise respective indications for failures experienced on each bandwidth part.

The report message may be formatted in a number of different ways. For example, in different embodiments of the disclosure, the report message may be conveyed via a transmission on the physical random access channel (PRACH), such as a msg1, msg3 or msgA; alternatively or additionally, the report message may be conveyed via a transmission on an uplink control channel such as the physical uplink control channel (PUCCH); alternatively or additionally, the report message may be formatted in the MAC layer (e.g., as a control element or in a MAC sub-header); alternatively or additionally, the report message may be formatted in the RRC layer (e.g., as a new, dedicated RRC signalling message, or as part of another RRC signalling message).

In one particular embodiment, the report message may comprise a MAC CE. A MAC CE may be configured or defined for the purposes of reporting consistent failures. This MAC CE may be a new MAC CE, dedicated for the purposes of reporting consistent failures, or re-use an existing MAC CE. Where a new MAC CE is defined, a new logical channel identity (LCH ID) may be introduced. The new MAC CE may contain no payload bits. In this case, the new MAC CE together with an identifier such as Cell Radio Network Temporary Identifier (C-RNTI) MAC CE will indicate to the network which wireless device has experienced consistent failures.

Alternatively, the report message may comprise RRC signalling, such as a new RRC signalling message introduced for the purposes of reporting consistent failure. The new message may be named for example as “IbtFailure-Info”. Alternatively, the UE may use an existing RRC signaling message to report the occurrence of consistent failures. One or several RRC information elements (IEs) may be introduced accordingly.

As noted above, in another embodiment the report message may be transmitted over a control channel (e.g., PUCCH). In this embodiment, separate control channel resources (e.g., transmission frequency resources and/or time resources) may be allocated for this purpose. Alternatively or additionally, a new PUCCH format may be defined, or an existing PUCCH format used for transmitting the report message. In one example, the report message uses PUCCH scheduling request (SR) signaling combined with transmission using specific PUCCH resources to indicate consistent failure.

In some embodiments, the report message may comprise no information beyond an indication that the wireless device has experienced consistent failure. In other embodiments, the report message may comprise additional information, such as one or more of the following:
Indication of the event which triggered transmission of the report message.
Indication that a number of LBT failures has reached a predefined threshold.
Indication that a number of beam failures has reached a predefined threshold.
Channel occupancy, e.g. based on RSSI.
LBT statistics, such as one or more of: number of LBT failures and/or successes, LBT failure/success ratio (e.g. calculated or averaged over a certain time period or using exponential averaging of successive time periods), LBT failure rate (e.g. calculated or averaged over a certain time period or using exponential averaging of successive time periods). Any or all of these statistics may be reported per LBT type, per CAPC, per transmission direction (e.g., UL or DL), per service, per LCH, or per LCG.
One or more radio quality indicators, such as RSRP, RSRQ, RSSI, SNR, SINR, etc.
Service QoS indicators such as latency, packet loss, priority, jitter etc.
Buffer status report.
Power headroom report.
Indications of one or more of the cell(s), bandwidth part(s) (BWPs), carrier(s), channel(s), subband(s) and PLMN(s) on which the failures were experienced, or which suffer from failures or high channel occupancy.
An indication of one or more recovery or mitigation actions that the wireless device would prefer to take place for recovering from or mitigating the failures. The mitigation actions may comprise one or more of: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch. Indications (e.g., indices) may also be included for the new cells/BWPs/carriers/channels/subbands to which the wireless device would prefer to be switched.

As noted above, the wireless device may be configured with multiple serving cells. Thus it may occur that consistent failure is detected in more than one of the serving cells at the same time. Similarly, where consistent failure is detected with a particular granularity (such as per bandwidth part), consistent failure may be detected in multiple bandwidth parts at the same time. In such cases, separate report messages may be transmitted in respect of each consistent failure event, or a single report message may be transmitted in respect of multiple consistent failure events. In either case, the resources identified in step 704 may be insufficient to transmit indications of all detected consistent failures. Thus the wireless device may select from the multiple consistent failure events to be reported via the transmission on the identified resources.

In one embodiment, the wireless device may select the consistent failure events in accordance with the priority order configured in step 902. Thus the priority order may be configured by a configuration message received from a network node. Alternatively or additionally, the wireless device may apply one or more rules to the selection of consistent failure events to be reported.

For example, consistent failure events detected on a PCell may be associated with a higher priority than consistent failure events detected on SCells or SpCells. Cells of the same type (such as SCells) may be differentiated based on one or more of: a cell index value of the cells (e.g., lower cell index values may have higher priority, or vice versa); a bandwidth of the cells (e.g., cells having higher bandwidth may have higher priority); an ability of the cells to satisfy quality of service criteria (e.g., cells which are better able to satisfy quality of service criteria have higher priority); a latency of transmissions to the cells (e.g., cells having lower latency have higher priority); and a robustness of transmissions to the cells (e.g., cells having greater robustness have higher priority).

Consistent failure events associated with higher priority are reported (e.g., report messages are allocated to the available radio resources) prior to consistent failure events with lower priority.

In step 906, the network node causes performance of one or more mitigating actions, to mitigate the consistent failure or high channel occupancy experienced by the wireless device. For example, the network node may transmit an instruction to the wireless device, to another network node (e.g., in the radio access network) and/or to a core network node to perform the mitigation action. The mitigation action may correspond to a preferred mitigation action indicated in the report message, or another mitigation action.

According to embodiments of the disclosure, the mitigation actions may comprise one or more of the following:
1) Handover UE(s) to other cell(s) with low channel occupancy/congestion/LBT failure ratio, where the wireless device will have higher probabilities of successful LBT.
2) Switch the wireless device to other BWP(s) with low channel occupancy/congestion/LBT failure ratio, where the UE(s) will have higher probabilities of successful LBT.
3) Switch the wireless device from one serving carrier to another carrier with low channel occupancy/congestion/LBT failure ratio, where the UE(s) will have better possibilities of successful LBT.
4) Switch the wireless device from one serving channel/subband to one or more other channel(s)/subband(s) with low channel occupancy/congestion/LBT failure ratio, where the UE(s) will have higher probabilities of successful LBT.
5) Perform reconfiguration of specific RAN functions such as PUCCH, PDCCH, RACK DRX, SRS configuration, timing advance configuration or data transmission related functions etc.
6) Perform reconfiguration of RLF declaration/triggering conditions.
7) Change the RRC status of the wireless device.
8) Increase or decrease the scheduling rate or change the scheduling priority of the wireless device.
9) Increase the size of the transport block scheduled in UL grants, so that the wireless device can transmit more data once they manage to transmit, i.e. when LBT succeeds.
10) Switch operating band for a cell, possibly handing over all UEs on that cell to other cells. That is, stopping the use of a band that is severely affected by interference or problems to access the channel.
11) Configure the wireless device with prepared actions in case it detects consistent LBT failures

In some embodiments, the one or more mitigation actions may be performed for a group of wireless devices (e.g., a plurality of wireless devices), to which the wireless device belongs. The wireless devices may be grouped according to one or more of the following criteria:
1) Belonging to the same serving cell/carrier/active BWP/channel/subband/beam/group of beams/sector as the reporting wireless device.
2) Have the same UE category/capabilities as the wireless device.
3) Carrying services with similar QoS requirements as the reporting wireless device. This may be augmented, e.g. by information about the UE's traffic pattern, e.g. the information carried in the Additional QoS Flow Information IE in the Initial Context Setup Request NGAP message in NR and/or the information contained in the Expected UE Behaviour IE in the Initial Context Setup Request S1AP message in LTE.
4) Having similar traffic pattern/characteristics, e.g. in terms of the rate of “produced” uplink data and how frequently the wireless device attempts to transmit.
5) Wireless devices having sent an LBT/CO statistics report indicating high channel occupancy or high LBT failure fraction.
6) Wireless devices which have failed to transmit data on allocated UL grants, e.g. at least a certain number of times during a given period or at least at a certain rate or fraction of all their/its UL grants, etc.

Thus the mitigation action may be performed for all wireless devices (i.e., in the group) which are experiencing, or which are likely to experience, LBT failures.

In step 908, the network node causes transmission, to one or more other network nodes, of an indication of the consistent failures reported to it in step 904. Note that step 908 may take place at the same time or earlier than step 906. The one or more other network nodes may include radio access network nodes, such as those which neighbour the network node performing the method shown in FIG. 9. The indication may be transmitted over a direct interface between the network nodes, such as an X2 interface.

In this way, neighbouring network nodes are enabled to take the same or similar mitigation actions as performed by the network node e.g., in step 906).

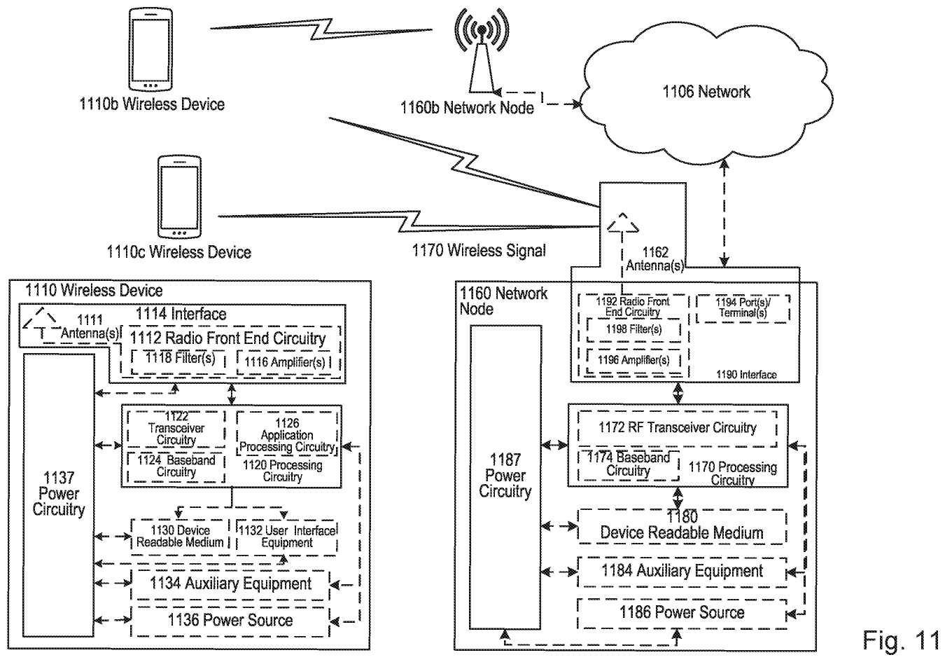

FIG. 10 illustrates a schematic block diagram of an apparatus 1000 in a wireless network (for example, the wireless network shown in FIG. 11). The apparatus may be implemented in a network node (e.g., network node 1160 shown in FIG. 11). Apparatus 1000 is operable to carry out the example method described with reference to FIG. 9 and possibly any other processes or methods disclosed herein. It is also to be understood that the method of FIG. 9 is not necessarily carried out solely by apparatus 1000. At least some operations of the method can be performed by one or more other entities.

Virtual Apparatus 1000 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1002, and any other suitable units of apparatus 1000 to perform corresponding functions according one or more embodiments of the present disclosure.

As illustrated in FIG. 10, apparatus 1000 includes receiving unit 1002. Receiving unit 1002 is configured to receive, from a wireless device, a report message comprising an indication of consistent failure experienced by the wireless device when attempting to communicate with the network node (e.g., a base station) or another network node (e.g., another base station).

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 11 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band Internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

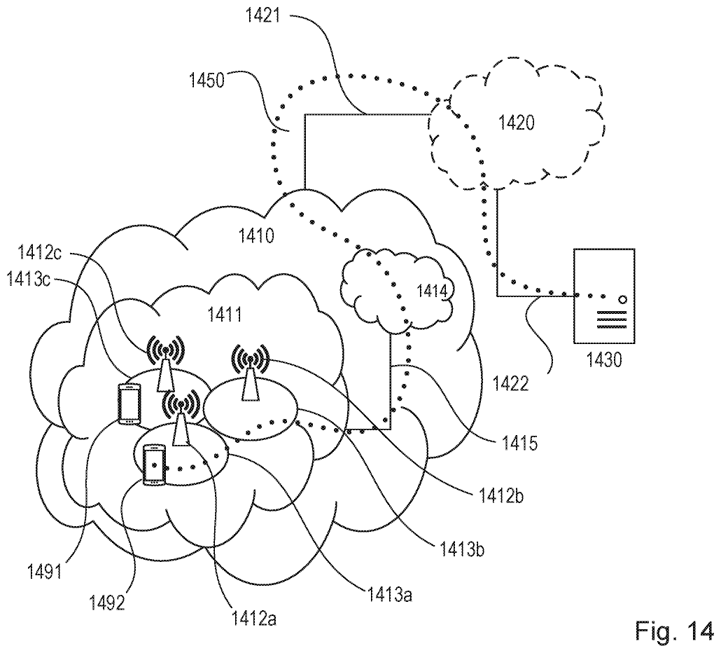

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NRV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

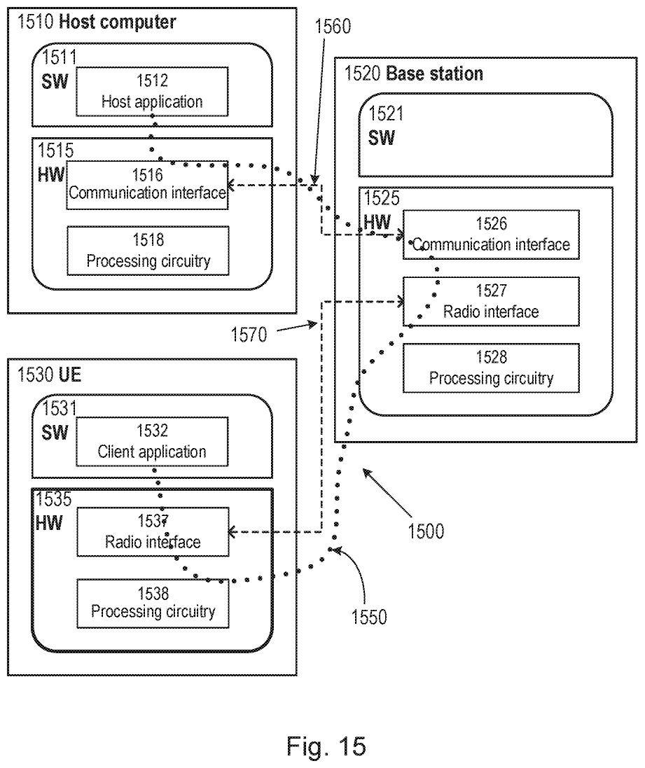

With reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

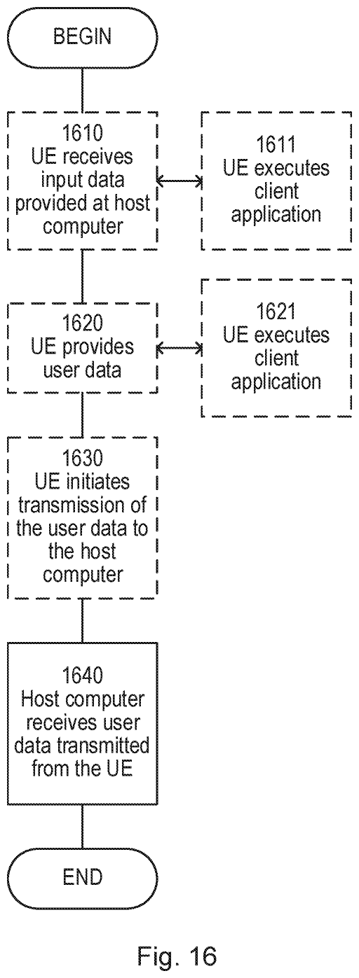

Example implementations, in accordance with an embodiment, of the UE, base station and host computer discussed in the preceding paragraphs will now be described with reference to FIG. 15. In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1513, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the robustness and latency of communications and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

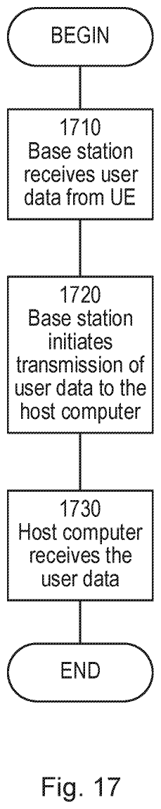

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610 (which, may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

For the avoidance of doubt, the following numbered statements set out embodiments of the disclosure.

Group A Embodiments
1. A method performed by a wireless device, the method comprising:
   transmitting, to a network node, a report message comprising an indication of consistent failure experienced by the wireless device when attempting to communicate with the network node or another network node.
2. The method of embodiment 1, wherein the indication of consistent failure comprises an indication of consistent Listen-Before-Talk, LBT, failures experienced by the wireless device when attempting to communicate with the network node or another network node.
3. The method of embodiment 1, wherein the indication of consistent failure comprises an indication of a predetermined number of beam failures experienced by the wireless device when attempting to communicate with the network node or another network node.
4. The method of embodiment 3, wherein the indication of a predetermined number of beam failures comprises a beam failure recovery request.
5. The method of any one of the preceding embodiments, wherein the report message comprises a Medium Access Control, MAC, control element, CE.
6. The method of any one of the preceding embodiments, wherein, responsive to a determination that the wireless device has an UL grant of radio resources, the report message is transmitted using the UL grant of radio resources.
7. The method of any one of the preceding embodiments, further comprising, responsive to a determination that the wireless device has no UL grant of radio resources, transmitting a scheduling request message to the network node.
8. The method of any one of the preceding embodiments, further comprising, responsive to a determination that the wireless device has a plurality of UL grants of radio resources, selecting one of the plurality of UL grants of radio resources, and wherein the report message is transmitted using the selected UL grant of radio resources.
9. The method of embodiment 8, wherein selecting one of the plurality of UL grants of radio resources comprises selecting an UL grant of the plurality of UL grants of radio resources having the lowest latency.
10 The method of embodiment 8, wherein selecting one of the plurality of UL grants of radio resources comprises selecting an UL grant of the plurality of UL grants of radio resources having the greatest transmission reliability.
11. The method of embodiment 8, wherein selecting one of the plurality of UL grants of radio resources comprises selecting an UL grant of the plurality of UL grants of radio resources having the highest priority.
12. The method of embodiment 8, wherein the plurality of UL grants of radio resources are associated with a plurality of serving cells, and wherein selecting one of the plurality of UL grants of radio resources comprises selecting an UL grant of the plurality of UL grants of radio resources based on cell index values of the associated serving cells.
13. The method of any one of the preceding embodiments, wherein the report message is contained in a transmission to the network node, and wherein the wireless device has information associated with a plurality of logical channels available for allocation to the transmission, the method further comprising allocating the information to the transmission in an order according to priorities of the plurality of logical channels.
14. The method of embodiment 13, wherein the priority of a first logical channel to which the report message belongs is lower than a priority of a second logical channel to which a Cell Radio Network Temporary Identifier Medium Access Control Control Element (C-RNTI MAC CE) belongs.
15. The method of embodiment 13 or 14, wherein the priority of a or the first logical channel to which the report message belongs is higher than a priority of one or more third logical channels to which one or more of the following belong: a Configuration Grant Confirmation; a Buffer Status Report; a Single- or Multiple-Entry Power Headroom Report; user data; a Recommended bit rate query; and a Buffer Status Report for padding.
16. The method of any one of the preceding embodiments, wherein the report message is contained in a transmission which does not comprise user data.
17. The method of any one of the preceding embodiments, wherein the indication of consistent failure experienced by the wireless device relates to a particular portion or part of the bandwidth of a carrier configured for the wireless device.
18. The method of any one of the preceding embodiments, further comprising starting or restarting a retransmission timer upon transmission of the report message and, upon expiry of the retransmission timer, retransmitting the report message.
19. The method of embodiment 18, wherein the retransmission timer is stopped upon receipt of a response message from the network node.
20. The method of embodiment 19, wherein the response message comprises an acknowledgement in respect of the report message.
21. The method of embodiment 19, wherein the response message comprises an indication that the network node has taken action to mitigate the consistent failure experienced by the wireless device.
22. The method of any one of embodiments 18 to 21, wherein the retransmission timer relates to: a particular portion or part of the bandwidth of a carrier configured for the wireless device; a particular cell; a particular carrier; a particular channel; a particular frequency subband; a particular public land mobile network, PLMN; a particular type of LBT; a particular channel access priority class, CAPC; a particular transmission direction, e.g. UL or DL; a particular service accessed by the wireless device; a particular logical channel; and a particular logical channel group.
23. The method of any one of the preceding embodiments, further comprising starting a prohibit timer upon transmission of the report message and, while the prohibit timer is running, prohibiting the wireless device from transmitting a further indication of consistent failure experienced by the wireless device when attempting to communicate with the network node or another network node.
24. The method of embodiment 23, wherein the prohibit timer relates to: a particular portion or part of the bandwidth of a carrier configured for the wireless device; a particular cell; a particular carrier; a particular channel; a particular frequency subband; a particular public land mobile network, PLMN; a particular type of LBT; a particular channel access priority class, CAPC; a particular transmission direction, e.g. UL or DL; a particular service accessed by the wireless device; a particular logical channel; and a particular logical channel group.
25. The method of any one of the preceding embodiments, wherein the wireless device is configured with a plurality of serving cells, and wherein the wireless device experiences consistent failure when attempting to communicate with two or more of the plurality of serving cells, the method comprising transmitting, to the network node, respective report messages for each of the two or more serving cells.
26. The method of embodiment 25, wherein the respective report messages are transmitted in an order according to a priority of the two or more serving cells.
27. The method of embodiment 26, wherein the two or more serving cells comprise a primary cell and one or more secondary cells, and wherein the primary cell has a higher priority than the two or more serving cells.
28. The method of embodiment 26 or 27, wherein the two or more serving cells comprise a plurality of secondary cells, and wherein the priority of the secondary cells is defined based on one or more of: a cell index value of the secondary cells; a bandwidth of the secondary cells; an ability of the secondary cells to satisfy quality of service criteria; a latency of transmissions to the secondary cells; and a robustness of transmissions to the secondary cells.
29. The method of any one of embodiments 26 to 28, further comprising receiving, from the network node, an indication of the priority of each of the plurality of serving cells.
30. The method of any of the previous embodiments, further comprising:
   providing user data; and
   forwarding the user data to a host computer via the transmission to the network node.

Group B Embodiments
31. A method performed by a base station, the method comprising:
   receiving, from a wireless device, a report message comprising an indication of consistent failure experienced by the wireless device when attempting to communicate with the base station or another base station.
32. The method of embodiment 31, wherein the indication of consistent failure comprises an indication of consistent Listen-Before-Talk, LBT, failures experienced by the wireless device when attempting to communicate with the base station or another base station.
33. The method of embodiment 31, wherein the indication of consistent failure comprises an indication of a predetermined number of beam failures experienced by the wireless device when attempting to communicate with the base station or another base station.
34. The method of embodiment 33, wherein the indication of a predetermined number of beam failures comprises a beam failure recovery request.
35. The method of any one of embodiments 31 to 34, wherein the report message comprises a Medium Access Control, MAC, control element, CE.
36. The method of any one of embodiments 31 to 35, wherein the indication of consistent failure experienced by the wireless device relates to a particular portion or part of the bandwidth of a carrier configured for the wireless device.
37. The method of any one of embodiments 31 to 36, wherein the wireless device is configured with a plurality of serving cells, and wherein the wireless device experiences consistent failure when attempting to communicate with two or more of the plurality of serving cells, the method comprising receiving, from the wireless device, respective report messages for each of the two or more serving cells.
38. The method of embodiment 37, wherein the respective report messages are received in an order according to a priority of the two or more serving cells.
39. The method of embodiment 38, wherein the two or more serving cells comprise a primary cell and one or more secondary cells, and wherein the primary cell has a higher priority than the two or more serving cells.
40. The method of embodiment 38 or 39, wherein the two or more serving cells comprise a plurality of secondary cells, and wherein the priority of the secondary cells is defined based on one or more of: a cell index value of the secondary cells; a bandwidth of the secondary cells; an ability of the secondary cells to satisfy quality of service criteria; a latency of transmissions to the secondary cells; and a robustness of transmissions to the secondary cells.
41. The method of any one of embodiments 38 to 40, further comprising transmitting, to the wireless device, an indication of the priority of each of the plurality of serving cells.
42. The method of any one of embodiments 31 to 41, wherein the report message is contained in a transmission which does not comprise user data.
43. The method of any of the previous embodiments, further comprising:
   obtaining user data; and
   forwarding the user data to a host computer or a wireless device.

Group C Embodiments
44. A wireless device, the wireless device comprising:
   processing circuitry configured to perform any of the steps of any of the Group A embodiments; and
   power supply circuitry configured to supply power to the wireless device.
45. A base station, the base station comprising:
   processing circuitry configured to perform any of the steps of any of the Group B embodiments;
   power supply circuitry configured to supply power to the base station.
46. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
47. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
48. The communication system of the previous embodiment further including the base station.
49. The communication system of the previous 2 embodiments, further including the UE, wherein the UE is configured to communicate with the base station.
50. The communication system of the previous 3 embodiments, wherein:
   the processing circuitry of the host computer is configured to execute a host application, thereby providing the user data; and
   the UE comprises processing circuitry configured to execute a client application associated with the host application.
51. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
52. The method of the previous embodiment, further comprising, at the base station, transmitting the user data.
53. The method of the previous 2 embodiments, wherein the user data is provided at the host computer by executing a host application, the method further comprising, at the UE, executing a client application associated with the host application.
54. A user equipment (UE) configured to communicate with a base station, the UE comprising a radio interface and processing circuitry configured to performs the of the previous 3 embodiments.
55. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
56. The communication system of the previous embodiment, wherein the cellular network further includes a base station configured to communicate with the UE.
57. The communication system of the previous 2 embodiments, wherein;
   the processing circuitry of the host computer is configured to execute a host application, thereby providing the user data; and
   the UE's processing circuitry is configured to execute a client application associated with the host application.
58. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
59. The method of the previous embodiment, further comprising at the UE, receiving the user data from the base station.
60. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
61. The communication system of the previous embodiment, further including the UE.
62. The communication system of the previous 2 embodiments, further including the base station, wherein the base station comprises a radio interface configured to communicate with the UE and a communication interface configured to forward to the host computer the user data carried by a transmission from the UE to the base station.
63. The communication system of the previous 3 embodiments, wherein:
   the processing circuitry of the host computer is configured to execute a host application; and
   the UE's processing circuitry is configured to execute a client application associated with the host application, thereby providing the user data.
64. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
65. A method implemented in a communication system including a host computer, a base station and a user equipment (UE), the method comprising:
   at the host computer, receiving user data transmitted to the base station from the UE, wherein the UE performs any of the steps of any of the Group A embodiments.
66. The method of the previous embodiment, further comprising, at the UE, providing the user data to the base station.
67. The method of the previous 2 embodiments, further comprising:
   at the UE, executing a client application, thereby providing the user data to be transmitted; and
   at the host computer, executing a host application associated with the client application.
68. The method of the previous 3 embodiments, further comprising:
at the UE, executing a client application; and
   at the UE, receiving input data to the client application, the input data being provided at the host computer by executing a host application associated with the client application,
   wherein the user data to be transmitted is provided by the client application in response to the input data.
69. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
70. The communication system of the previous embodiment further including the base station.
71. The communication system of the previous 2 embodiments, further including the UE, wherein the UE is configured to communicate with the base station.
72. The communication system of the previous 3 embodiments, wherein:
   the processing circuitry of the host computer is configured to execute a host application;
   the UE is configured to execute a client application associated with the host application, thereby providing the user data to be received by the host computer.
73. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
74. The method of the previous embodiment, further comprising at the base station, receiving the user data from the UE.
75. The method of the previous 2 embodiments, further comprising at the base station, initiating a transmission of the received user data to the host computer.

1-19. (canceled)

20. A method performed by a wireless device, the method comprising:
transmitting, to a network node, a report message comprising an indication of consistent failure experienced by the wireless device when attempting to communicate with the network node or another network node; and
starting or restarting a retransmission timer upon transmission of the report message; and
retransmitting the report message upon expiry of the retransmission timer.

21. The method of claim 20, wherein the retransmission timer is stopped upon receipt of a response message from the network node.

22. The method of claim 21, wherein the response message comprises:
an acknowledgement in respect of the report message; and/or
an indication that the network node has taken action to mitigate the consistent failure experienced by the wireless device.

23. The method of claim 20, wherein the retransmission timer relates to:
a particular portion or part of the bandwidth of a carrier configured for the wireless device;
a particular cell;
a particular carrier;
a particular channel;
a particular frequency subband;
a particular public land mobile network;
a particular type of Listen-Before-Talk (LBT);
a particular channel access priority class;
a particular transmission direction;
a particular service accessed by the wireless device;
a particular logical channel; and/or
a particular logical channel group.

24. The method of claim 20, further comprising:
starting a prohibit timer upon transmission of the report message; and,
prohibiting, while the prohibit timer is running, the wireless device from transmitting a further indication of consistent failure experienced by the wireless device when attempting to communicate with the network node or another network node.

25. The method of claim 24, wherein the prohibit timer relates to:
a particular portion or part of the bandwidth of a carrier configured for the wireless device;
a particular cell;
a particular carrier;
a particular channel;
a particular frequency subband;
a particular public land mobile network;
a particular type of Listen-Before-Talk (LBT);
a particular channel access priority class;
a particular transmission direction;
a particular service accessed by the wireless device;
a particular logical channel; and/or
a particular logical channel group.

26. The method of claim 20:
wherein the wireless device is configured with a plurality of serving cells; and
wherein the method comprises transmitting, to the network node and in response to the wireless device experiencing consistent failure when attempting to communicate with two or more of the plurality of serving cells, respective report messages for each of the two or more serving cells.

27. The method of claim 26, wherein the respective report messages are transmitted in an order according to a priority of the two or more serving cells.

28. The method of claim 27, wherein the two or more serving cells comprise a primary cell and one or more secondary cells, and wherein the primary cell has a higher priority than the two or more serving cells.

29. The method of claim 27:
wherein the two or more serving cells comprise a plurality of secondary cells; and
wherein the priority of the secondary cells is defined based on:
a cell index value of the secondary cells;
a bandwidth of the secondary cells;
an ability of the secondary cells to satisfy quality of service criteria;
a latency of transmissions to the secondary cells; and/or
a robustness of transmissions to the secondary cells.

30. The method of claim 27, further comprising receiving, from the network node, an indication of the priority of each of the plurality of serving cells.

31. The method of claim 20, wherein the indication of consistent failure comprises an indication of consistent Listen-Before-Talk (LBT) failures experienced by the wireless device when attempting to communicate with the network node or another network node.

32. The method of claim 31, wherein the indication of consistent failure comprises an indication of a predetermined number of beam failures experienced by the wireless device when attempting to communicate with the network node or another network node.

33. The method of claim 32, wherein the indication of a predetermined number of beam failures comprises a beam failure recovery request.

34. The method of claim 20:
further comprising, responsive to a determination that the wireless device has a plurality of uplink (UL) grants of radio resources, selecting one of the plurality of UL grants of radio resources;
wherein the report message is transmitted using the selected UL grant of radio resources.

35. The method of claim 34, wherein selecting one of the plurality of UL grants of radio resources comprises:
selecting an UL grant of the plurality of UL grants of radio resources having the lowest latency;
selecting an UL grant of the plurality of UL grants of radio resources having the greatest transmission reliability; or
selecting an UL grant of the plurality of UL grants of radio resources having the highest priority.

36. The method of claim 34:
wherein the plurality of UL grants of radio resources are associated with a plurality of serving cells; and
wherein selecting one of the plurality of UL grants of radio resources comprises selecting an UL grant of the plurality of UL grants of radio resources based on cell index values of the associated serving cells.

37. A wireless device, comprising:
processing circuitry configured to cause the wireless device to:
transmit, to a network node, a report message comprising an indication of consistent failure experienced by the wireless device when attempting to communicate with the network node or another network node; and
start or restart a retransmission timer upon transmission of the report message and, upon expiry of the retransmission timer, retransmit the report message; and
power supply circuitry configured to supply power to the wireless device.

38. The wireless device of claim 37, wherein the processing circuitry is configured to cause the wireless device to:
start a prohibit timer upon transmission of the report message; and,
prohibit, while the prohibit timer is running, the wireless device from transmitting a further indication of consistent failure experienced by the wireless device when attempting to communicate with the network node or another network node.

39. The wireless device of claim 38, wherein the prohibit timer relates to:
a particular portion or part of the bandwidth of a carrier configured for the wireless device;
a particular cell;
a particular carrier;
a particular channel;
a particular frequency subband;
a particular public land mobile network;
a particular type of Listen-Before-Talk (LBT);
a particular channel access priority class;
a particular transmission direction;
a particular service accessed by the wireless device;
a particular logical channel; and/or
a particular logical channel group.
